(19) United States
(12) Patent Application Publication
(10) Pub. No.: US 2006/0121283 A1
(43) Pub. Date: Jun. 8, 2006

(54) Insulating material piece for an electrical high voltage device and method for production thereof

(75) Inventor: Eberhard Zielke, Berlin (DE)

Correspondence Address: MORRISON & FOERSTER LLP, 1650 TYSONS BOULEVARD, SUITE 300, MCLEAN, VA, 22102, US

(73) Assignee: Siemens AG, Munchen (DE)

(21) Appl. No.: 10/539,761

(22) PCT Filed: Nov. 21, 2003
(86) PCT No.: PCT/DE03/03889

§ 371 Date: Jun. 20, 2005

(51) Int. Cl. B32B 27/00

(52) U.S. Cl. 428/411.1; 428/422

(57) ABSTRACT

An insulating material piece (1), for an electrical high voltage device, comprises a part volume (3), the conductivity of which is changed by means of a treatment. Said treatment can for example be carried out by chemical or mechanical methods or the action of high-energy radiation such as alpha, beta or gamma radiation. According to the invention, a high rigidity for the insulating material piece (1) can be achieved, whereby the insulating material piece (1) is at least partly made from a mixture of treated part volumes (3) and untreated part volumes (4).

### CLAIM FOR PRIORITY

This application claims the benefit of priority to German Application No. 102 61 846.1, which was filed in the German language on Dec. 20, 2002, the contents of which are hereby incorporated by reference.

### TECHNICAL FIELD OF THE INVENTION

The invention relates to an insulating material piece for an electrical high-voltage device, in particular for a high-voltage power breaker, the insulating material piece having at least one subvolume which is treated so as to change its conductivity, and to a method for producing such an insulating material piece.

### BACKGROUND OF THE INVENTION

An insulating material piece is known, for example, from patent specification DE 198 26 202 C2. In order to reduce the electrical resistance in surface areas which are subjected to increased dielectric load, these areas of the manufactured insulating material piece are irradiated with beta or gamma radiation. Treatment with high-energy radiation influences the particle bonds of the insulating material. In particular in the case of plastics, which have long-chain compounds, breakage of the particle bonds brings about embrittlement of the material. As a result, the mechanical strength is reduced. In order to achieve the robustness required for the technical application, the insulating material pieces which are treated in this manner are given correspondingly large dimensions.

### SUMMARY OF THE INVENTION

The invention discloses configuring an insulating material piece having at least one treated subvolume such that the insulating material piece has improved mechanical strength.

In one embodiment of the invention, there is an insulating material piece of the type mentioned initially by the insulating material piece at least partially comprising a mixture of treated subvolumes and untreated subvolumes.

A mixture of treated and untreated subvolumes makes it possible, depending on the mixing ratio of the volumes with respect to one another, to achieve increased robustness with an electrical conductivity which is different to that for the untreated material. It is thus possible, for example, to provide the untreated subvolumes in order to ensure the mechanical strength and to use the treated subvolumes for the purpose of influencing the electrical properties of the insulating material piece. Treatment can be carried out in accordance with various methods. It is thus possible to treat subvolumes mechanically, chemically or, for example, using high-energy radiation such as alpha, beta or gamma radiation.

A further advantageous embodiment may provide for the mixture to lie at least partially on the surface of the insulating material piece.

Mixture is understood here to mean the random distribution of various subvolumes within a total volume. The properties of the subvolumes which are combining with one another are not changed by this combination.

An arrangement of the mixture along the surface of the insulating material piece makes it possible to influence the electrical properties of the insulating material piece in a particularly simple and direct manner. It may also be provided for the entire insulating material piece to be formed from a homogeneous mixture of treated and untreated subvolumes. An arrangement of the mixture merely in specific surface areas of the insulating material piece allows for targeted control of the electrical behavior. It is thus possible for specific leakage current paths to be constructed in a targeted manner on the insulating material piece for dissipating surface charges. The leakage current paths may also pass through the interior of the insulating material piece and lead up to electrodes, for example.

Provision is advantageously also made for the treated subvolumes to be embedded in the untreated subvolumes.

Embedding of the treated subvolumes in the untreated subvolumes makes it possible for insulating material pieces to be produced which, whilst having high mechanical strength, have favorable properties as regards a changed electrical resistance, in particular on the surfaces of the insulating material piece. The untreated subvolumes are in this case provided for the purpose of ensuring sufficient dielectric strength and mechanical strength of the insulating material piece. The treated subvolumes influence these properties only at certain points and do not lead to substantial weakening of the insulating material piece as regards mechanical and dielectric properties. By selecting the mixing ratio of untreated and treated subvolumes, the degree of embedding can easily be influenced. A proportion of treated subvolumes which is less than that for untreated subvolumes provides for sufficient embedding when the components are mixed. In the case of a large proportion of treated subvolumes, they should be mixed in well, for example, in order to ensure sufficient embedding. The proportion of treated subvolumes in the total volume of the mixture may be, for example, 10, 20, 30, 40 or 50%.

Provision may be made for the subvolumes to be made of PTFE.

Polytetrafluoroethylene (PTFE) has a very high insulating capacity. One disadvantage of the very high insulating capacity is the fact that electrical charges collect on the surface of a PTFE insulating material piece but cannot flow away to a sufficient degree owing to the insulating capacity. Jeopardized areas are thus produced which have an increased electrical field strength which can cause the occurrence of electrical flashovers or partial discharges. A configuration according to the invention of insulating material pieces, which are formed from PTFE and which comprise treated and untreated subvolumes, reduces the risk of the occurrence of jeopardized areas.

In another embodiment of the invention, there is a simple and cost-effective method for producing an abovementioned insulating material piece for an electrical high-voltage device.

In the invention by treated subvolumes being mixed with untreated subvolumes, and the mixture being shaped so as to produce an insulating material piece.

Mixing treated and untreated subvolumes makes it possible to produce the mixing ratio with different compositions depending on the desired properties for the insulating material piece. In the process, it is possible to use various methods for treating the subvolumes.

Provision may furthermore be made for the mixture to be sintered.

The subvolumes are frequently present in the form of granules. The large number of individual subvolumes or granule particles can be combined in a suitable manner using the sintering method.

### BRIEF DESCRIPTION OF THE INVENTION

The invention will be illustrated schematically in the drawings with reference to an exemplary embodiment below and will be described in more detail in the text which follows.

In the drawings:

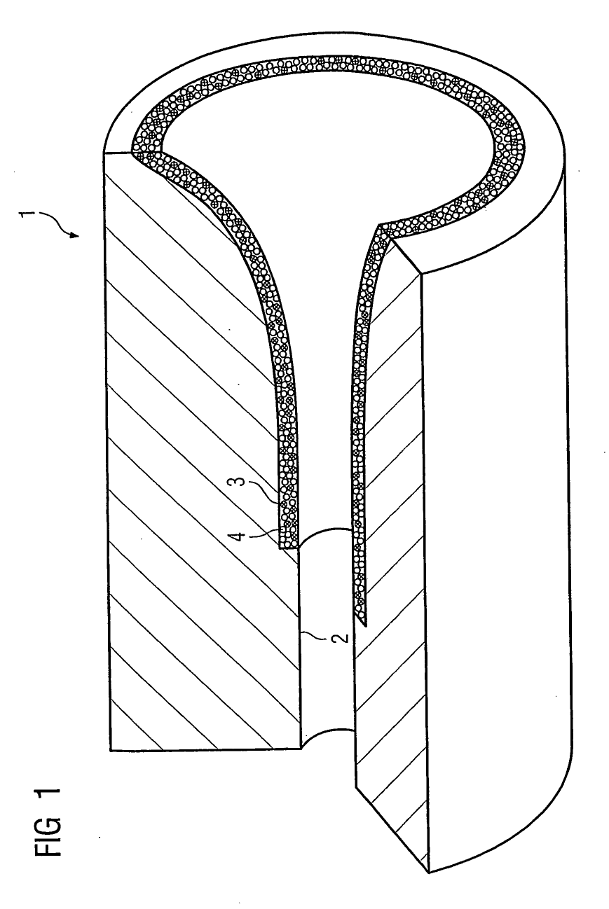

FIG. 1 shows a section through an insulating material nozzle.

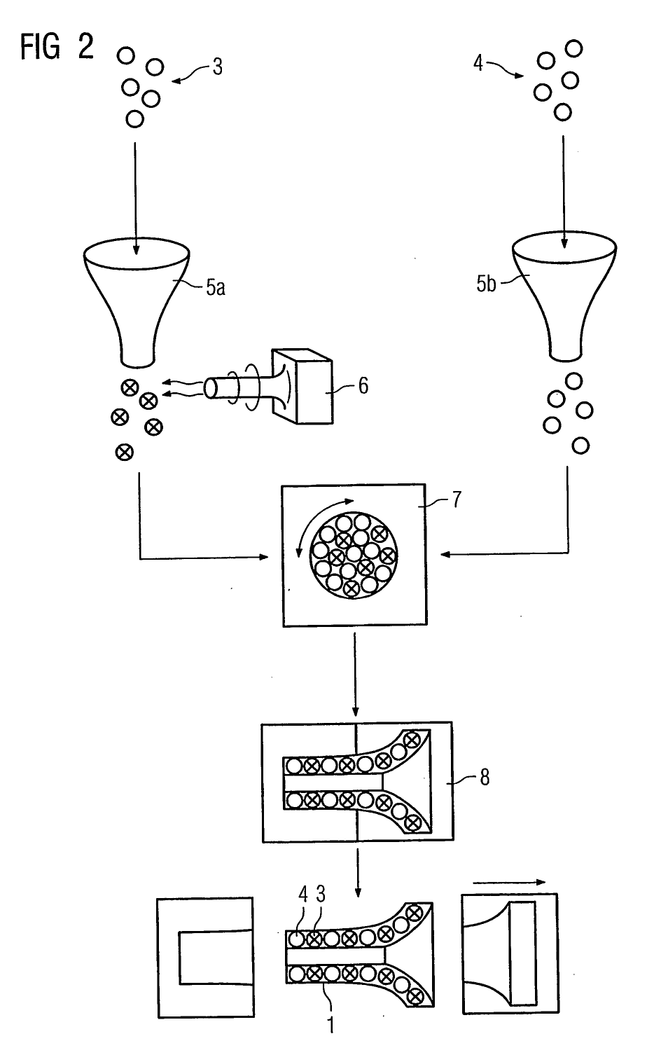

FIG. 2 shows a block diagram of a method for producing an insulating material nozzle.

### DETAILED DESCRIPTION OF THE INVENTION

An insulating material nozzle 1 illustrated in FIG. 1 is used in high-voltage power breakers in order to influence the burning and quenching of a switching arc and to direct the flow away of switching gases. The insulating material nozzle 1 has a base body which has a through-channel 2. The base body is formed from an insulating material, for example polytetrafluoroethylene (PTFE). The channel 2 is essentially in the form of a cylinder at one of its ends. At the other end, the channel 2 expands in the form of a funnel. At that end of the channel 2 which is in the form of a funnel, the surface of the insulating material nozzle 1 is partially formed from a mixture of a first subvolume 3 ( [symbol] ) and a second subvolume 4 (◯). The first subvolume 3 is formed from a large number of subvolumes (granules) which was subjected to high-energy radiation, for example alpha, beta or gamma radiation. The second subvolume 4 is untreated and is likewise formed from a large number of subvolumes. The treated subvolumes of the first subvolume 3 are embedded in the subvolumes of the second subvolume 4. That is to say, the subvolumes of the second subvolume 4 are present in greater quantities than the subvolumes of the first subvolume 3. In addition to the various configurations shown in FIG. 1, other surface areas of the insulating material nozzle 1 can also be formed using a mixture comprising treated subvolumes and untreated subvolumes. The further surface areas can be arranged on the insulating material nozzle, for example at the end or on the casing side. In addition, provision may furthermore be made for the entire insulating material nozzle 1 to be produced from a mixture of treated and untreated subvolumes.

A method for producing an insulating material nozzle which overall comprises a mixture of treated and untreated subvolumes is illustrated schematically in FIG. 2. The first subvolume 3, coming from a first collecting container 5a, is guided past a beam gun 6 and irradiated with gamma radiation. By varying the period of time for or intensity of the radiation, the electrical properties can be influenced to a varying degree. The second subvolume 4, coming from a second collecting container 5b, is fed to a mixing apparatus 7 as is the treated first subvolume 3. The required quantities of treated and untreated subvolumes are mixed with one another in the mixing apparatus 7. The mixture formed in this way is combined in a mold 8, for example by means of a compacting method, to form a molding. Then, the molding can be sintered to form a solid molding. At the end of the process, an insulating material nozzle is produced which is formed from a first subvolume 3 and a second subvolume 4. The insulating material nozzle can now be used or be subjected to further processing steps.

In accordance with this method, it is also possible to produce insulating material bodies which only partially have a mixture of treated and untreated subvolumes.

1. An insulating material piece for an electrical high-voltage device, the insulating material piece comprising at least one subvolume which is treated so as to change its conductivity,
wherein
the insulating material piece at least partially comprises a mixture of treated subvolumes and untreated subvolumes.

2. The insulating material piece as claimed in claim 1,
wherein
the mixture lies at least partially on the surface of the insulating material piece.

3. The insulating material piece as claimed in claim 1,
wherein
the treated subvolumes are embedded in the untreated subvolumes.

4. The insulating material piece as claimed in, claim 1, wherein
the subvolumes are made of PTFE.

5. A method for producing an insulating material piece for an electrical high-voltage device,
the insulating material piece having at least one subvolume which is treated so as to change its conductivity,
the method comprising:
mixing treated subvolumes are mixed with untreated subvolumes; and
shaping the mixture is shaped so as to produce an insulating material piece.

6. The method as claimed in claim 5,
wherein
the mixture is sintered.
